(19) United States
(12) Patent Application Publication
(10) Pub. No.: US 2017/0063658 A1
(43) Pub. Date: Mar. 2, 2017

(54) Shared Risk Group Vicinities and Methods

(71) Applicant: Huawei Technologies Co., Ltd., Shenzhen (CN)

(72) Inventor: Peter Ashwood-Smith, Gatineau (CA)

(21) Appl. No.: 14/836,720

(22) Filed: Aug. 26, 2015

(51) Int. Cl. H04L 12/26; H04L 12/707

(52) U.S. Cl. CPC H04L 43/0817; H04L 45/22

(57) ABSTRACT

A method of managing risk in a network including computing a first path between a source and a destination within the network, computing a second path between the source and the destination within the network, comparing a first risk zone of a first network element in the first path to a second risk zone of a second network element in the second path, the first risk zone is based on a first location-based risk identifier assigned to the first network element prior to computation of the first path, the second risk zone is based on a second location-based risk identifier assigned to the second network element prior to computation of the second path, and an overlap of the first risk zone and the second risk zone indicates that the first network element and the second network element have a shared risk.

### BACKGROUND

Shared risk resource group, which is commonly referred to as shared risk group (SRG), is a concept in network routing that apparently diverse connections may suffer from a common failure if links share a common, but non-obvious, risk or a common SRG. There are several types of SRGs. A shared risk link group (SRLG) is a set of identifiers assigned to the links of a network model. A shared risk node group (SRNG) is a set of identifiers assigned to the nodes of a network model. Each of the identifiers correlates to some “risk” of failure. Indeed, the risk is associated with a node or link in a network based on some physical risk to the node or link that cannot be automatically detected (e.g., is non-obvious).

As an example, two nodes may be co-located such that they share the same power circuit. Therefore, the two nodes share the risk of failing should that power circuit fail. In this case, the SRNG for each node would intersect at the risk associated with the power circuit.

The links or fiber spans in a network are typically fiber optic cables that connect two nodes. In practice, the fiber optic cables may be bundled in one concrete conduit or one power/telephone pole (e.g., aerial). Therefore, the two links share the risk of failing should that concrete conduit or power/telephone pole suffer damage. In this case, the SNLG for each link would intersect at the risk associated with the concrete conduit or power/telephone pole.

Thus, an SRG failure (e.g., an SRLG failure or an SRNG failure) may undesirably result in multiple circuits going down because of the failure of a common resource those networks share and depend on for continued correct operation.

### SUMMARY

In one embodiment, the disclosure includes a method of managing risk in a network including computing a first path between a source and a destination within the network, computing a second path between the source and the destination within the network, and comparing a first location of a first network element in the first path to a second location of a second network element in the second path, the first location is based on a first location-based risk identifier assigned to the first network element prior to computation of the first path, the second location is based on a second location-based risk identifier assigned to the second network element prior to computation of the second path, and the first network element and the second network element have a shared risk when the first location is within a predetermined threshold distance of the second location.

In another embodiment, the disclosure includes a method of managing risk in a network including computing a first path between a source and a destination within the network, computing a second path between the source and the destination within the network, and comparing a first risk zone of a first network element in the first path to a second risk zone of a second network element in the second path, the first risk zone is based on a first location-based risk identifier assigned to the first network element prior to computation of the first path, the second risk zone is based on a second location-based risk identifier assigned to the second network element prior to computation of the second path, and an overlap of the first risk zone and the second risk zone indicates that the first network element and the second network element have a shared risk.

In yet another embodiment, the disclosure includes a risk management device for managing risk in a network including a processor operably coupled to a memory, and a risk management module stored in memory that, when executed by the processor, is configured to compute a first path between a source and a destination within the network, compute a second path between the source and the destination within the network, and compare a first risk zone of a first network element in the first path to a second risk zone of a second network element in the second path, the first risk zone is based on a first location-based risk identifier assigned to the first network element prior to computation of the first path, the second risk zone is based on a second location-based risk identifier assigned to the second network element prior to computation of the second path, and an overlap of the first risk zone and the second risk zone indicates that the first network element and the second network element have a shared risk.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 depicts a representative portion of network having a plurality of paths extending between a source and a destination.

FIG. 2 depicts a representative portion of network having different domains.

FIG. 3 depicts a representative portion of network utilizing a universal location-based identifier for shared risk groups.

FIG. 4 is a graph depicting the determination of a shared risk in one embodiment using the location-based risk identifiers.

FIG. 5 is a graph depicting the determination of a shared risk in one embodiment using the location-based risk identifiers.

FIG. 6 depicts the intersection or overlap of a circle and a sphere.

FIG. 7 illustrates a typical, general-purpose network equipment.

FIG. 8 is a method of managing risk in a network in one embodiment.

FIG. 9 is a method of managing risk in a network in one embodiment.

FIG. 10 is a method of managing risk in a network in one embodiment.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein is a network utilizing a shared risk link group and/or shared risk node group vicinities for the computation of risk disjoint paths through the network. As will be more fully explained below, the shared risk link group and/or shared risk node group have identifiers that contain geographic (e.g., physical location) information. Therefore, a network administrator (e.g., a person and/or computer software) is able to check for overlaps in the physical positions of traversed network elements. If, for example, a network element (e.g., nodes, links, etc.) is within the same threshold distance as another network element, then those network elements share a risk (e.g., a risk that cannot be automatically detected or discovered) that is unacceptable and, therefore, their respective geographic locations or their respective paths through the network are not considered disjoint relative to that risk. Stated another way, the two network elements permitted to share a risk as those two elements are not within, for example, a predetermined distance of each other. To reduce the probability that the network is not subject to an outage based on a shared risk, new paths that do not share the risk are computed. This minimizes the probability that a single failure/risk will result in a loss of connectivity of both a primary and a backup circuit in the network.

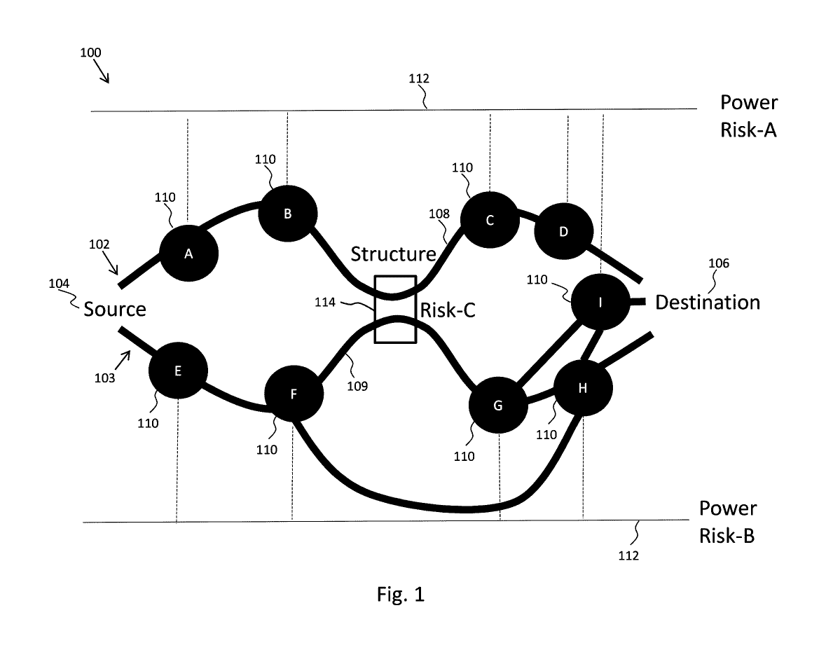

FIG. 1 depicts a representative portion of network 100 having a plurality of paths 102, 103 extending between a source 104 and a destination 106. The paths 102, 103 are defined by links 108, 109 (e.g., fiber optical transmission lines, etc.) coupling together various nodes 110 (individually labeled A-I) within the network 100. One or more of the paths 102, 103 may be used to transmit data through the network 100 from the source 104 to the destination 106.

The network 100 also includes a plurality of shared risk groups. For example, each of the nodes 110 labeled A, B, C, D, and I is reliant upon the same power source 112. If that power source 112 happens to fail, which may be deemed Risk-A, each of the nodes 110 labeled A, B, C, D, and I will lose power and may fail, thereby potentially interrupting traffic flow through the network 100. As such, the nodes 110 labeled A, B, C, D, and I are assigned a particular identifier to indicate that these nodes share a risk that exceeds an acceptable threshold and have been grouped together into a shared risk node group corresponding to Risk-A. Likewise, each of the nodes 110 labeled E, F, G, and H is reliant upon the same power source 112. If that power source 112 happens to fail, which may be deemed Risk-B, each of the nodes 110 labeled E, F, G, and H will lose power and may fail, thereby potentially interrupting traffic flow through the network 100. As such, the nodes 110 labeled E, F, G, and H are assigned a particular identifier to indicate that these nodes share a risk that exceeds an acceptable threshold and have been grouped together into a shared risk node group corresponding to Risk-B.

The particular identifier for the shared risk node group may be beneficially utilized when two disjoint paths 102, 103 through the network 100 are calculated. For example, the first path 102 through the network may include the nodes 110 labeled A, B, C, and D. Because the node 110 labeled I shares the same particular identifier as the nodes 110 labeled A, B, C, and D, the node 110 labeled I will not be used within the second path 103 to ensure that the two paths are disjoint (e.g., do not have a shared risk above a predetermined threshold). With the node 110 labeled I eliminated from consideration due to its particular identifier, only the nodes 110 labeled E, F, G, and H are available for the second path 103.

As another example, the link 108 between the nodes 110 labeled B and C and the link 109 between the nodes 110 labeled F and G both pass through the structure 114 (e.g., a conduit, bridge, building, roadway, etc.). If that structure 114 or the surrounding area suffers damage, which may be deemed Risk C, the link 108 between the nodes 110 labeled B and C and the link 109 between the nodes 110 labeled F and G may both fail. As such, the link 108 between the nodes 110 labeled B and C and the link 109 between the nodes 110 labeled F and G are assigned a particular identifier to indicate that these links share a risk that exceeds an acceptable threshold and have been grouped together into a shared risk link group corresponding to Risk-C. The particular identifier for the shared risk link group may be beneficially utilized when two disjoint paths 102, 103 through the network 100 are calculated. For example, the first path 102 through the network may include the link 108 between the nodes 110 labeled B and C. Because the link 109 between the nodes 110 labeled F and G shares the same particular identifier as the link 108 between the nodes 110 labeled B and C, the link 109 between the nodes 110 labeled F and G will not be used within the second path 103 to ensure that the two paths are disjoint (e.g., do not have a shared risk above a predetermined threshold). With the link 109 between the nodes 110 labeled F and G eliminated from consideration due to its particular identifier, only the nodes 110 labeled E, F, G, and H are available for the second path 103.

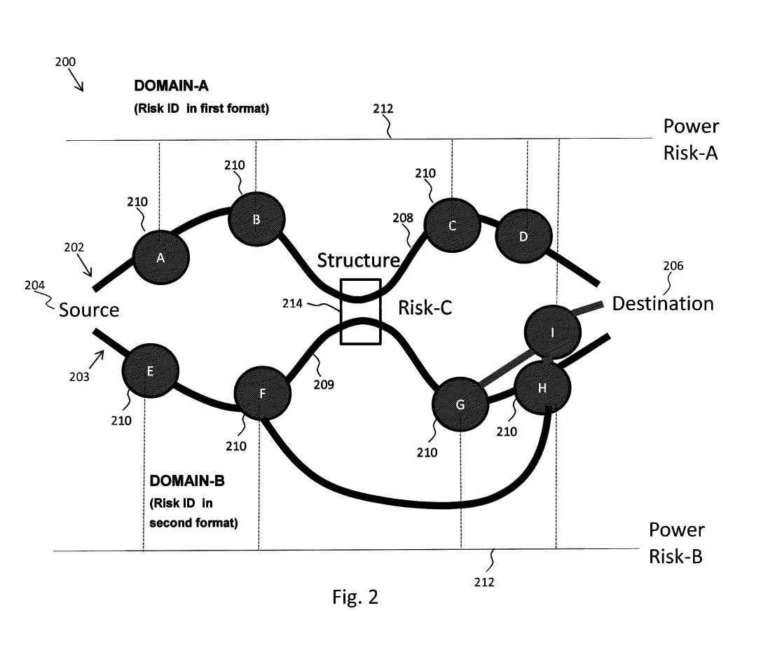

FIG. 2 depicts a representative portion of network 200 having different domains. The network 200 of FIG. 2 is similar to the network 100 of FIG. 1. For example, network 200 includes paths 202, 203, a source 204, a destination 206, links 208, 209, nodes 210, power sources 212, and a structure 214 similar to the paths 102, 103, source 104, destination 106, links 108, 109, nodes 110, power sources 112, and structure 114 of FIG. 1. However, network 200 is divided into a first domain labeled Domain-A and a second domain labeled Domain-B. As shown, not all of the nodes 210 and links 208, 209 are disposed in the same domain. For example, the nodes 210 labeled A, B, C, D, and I in the network 200 of FIG. 2 belong to Domain-A while the nodes 210 labeled E, F, G, and H belong to Domain-B. If Domain-A and Domain-B each use their own uniquely-formatted risk identifier for shared risk groups, then risks simultaneously affecting network elements in the different domains are extremely difficult, if not impossible, to assess. To remedy this, a system of coordination may be implemented to map the risk identifiers of Domain-A, which are in one format, to the risk identifiers of Domain-B, which are in a different format. However, this process is both expensive and error prone. As the number of domains increases, along with the number of elements and the number of risks accounted for, this becomes increasingly unwieldy and eventually become effectively impossible to track.

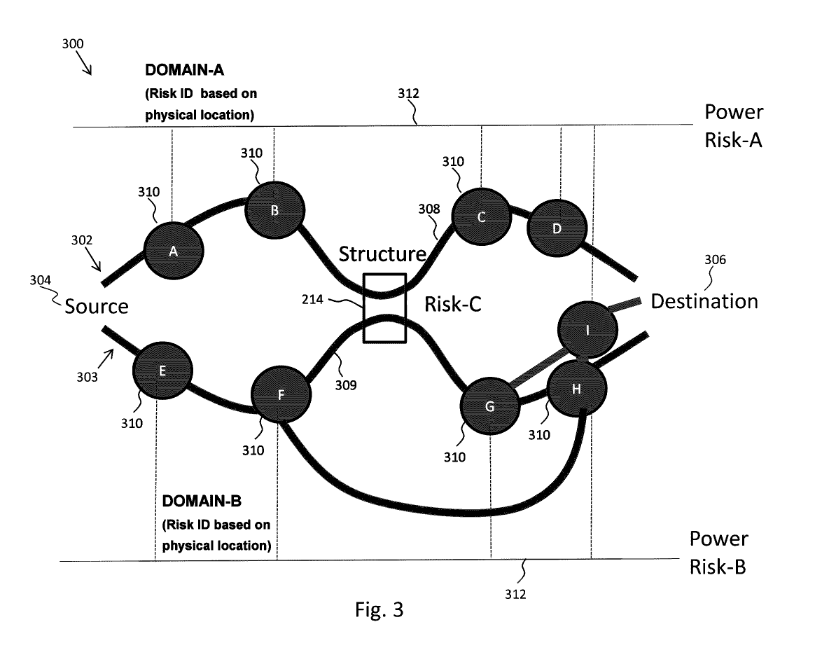

FIG. 3 depicts a representative portion of network 300 utilizing a universal location-based identifier for shared risk groups that attempts to resolve the issues present in the network of FIG. 2. The network 300 of FIG. 3 is similar to the network 200 of FIG. 2. For example, network 300 includes paths 302, 303, a source 304, a destination 306, links 308, 309, nodes 310, power sources 312, and a structure 314 similar to the paths 202, source 204, destination 206, links 208, nodes 210, power sources 212, structure 214, and separate domains (e.g., Domain-A, Domain-B) of FIG. 1. As will be more fully explained below, when a network element (e.g., node or link) in the network 300 is within a threshold distance of another network element based on the location-based risk identifiers of the network elements, those network elements share a risk and their respective paths through the network are not considered disjoint. To reduce the likelihood that the network is subject to an outage based on such a shared risk event, paths with elements (e.g., nodes, links) that do not have intersecting or overlapping vicinities based on their location-based risk identifiers are selected. As such, paths with a disjoint risk perspective can be selected in multi-domain network 300.

Unlike the network 200 of FIG. 2, the network 300 of FIG. 3 utilizes risk identifiers that can include a physical location of each network element (e.g., node or link). While the physical location of a node may be determined using, for example, global positioning system (GPS) measurements, the physical location for links, which may extend a considerable distance, may be assigned a representative or estimated physical location. The representative or estimated physical location may be manually assigned by, for example, a network architect during the design of the network, by a network administrator presently managing the network, and so on. The location-based risk identifiers are assigned to each network element, for example, at the time the network 300 is constructed, upgraded, maintained, and the like. The risk identifier for any given element can be determined when it is added. In other words, the location-based risk identifiers are available for each network element before path computations take place. The location-based risk identifiers may be assigned, for example, by one or more network administrators, by a risk management module operating on a computing device, or a combination thereof. Despite these different entities potentially assigning the location-based risk identifiers to network elements in different domains, the location-based risk identifiers have the same or similar format. In other words, the location-based risk identifiers are common or universal across the entire network 300 regardless of which domain a network element resides in.

In an embodiment, the location-based risk identifiers comprise a set of coordinates. For example, a location-based risk identifier may identify the latitude and longitude of a network element, which represents the position (e.g., physical location) of the network element in two dimensions. As another example, the location-based risk identifier may identify the latitude, longitude, and altitude of a network element, which represents the position of the network element in three dimensions. Physical links may be represented using geo-fencing techniques that allow for the definition of a series of line segments (or a path) through a map.

In an embodiment, any type of coordinate system may be utilized for the network 300 so long as the coordinate system is agreed upon between the different domains . Where the discussion of conventional risk mapping above indicated that mapping from one system to another can be difficult, the use of standardized positional references may allow for a simple translation of one co-ordinate system to another. For example, the coordinate system may be a Cartesian coordinate system, a cylindrical coordinate system, and a spherical coordinate system, and so on.

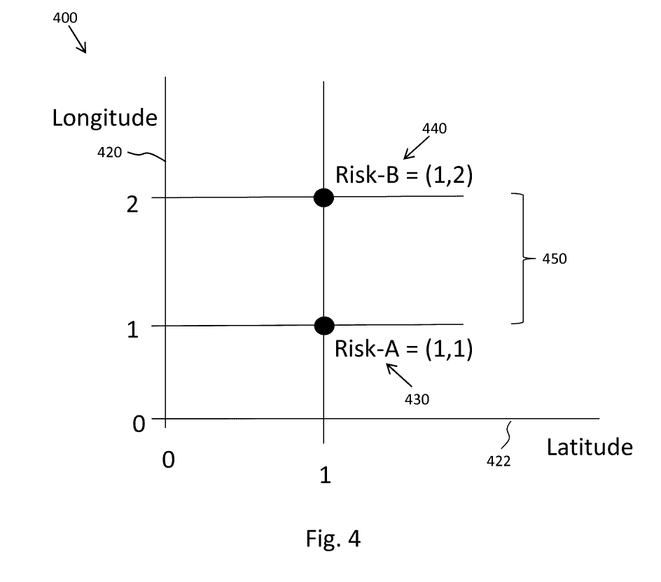

FIG. 4 is a graph 400 depicting the determination of a shared risk in one embodiment using the location-based risk identifiers described herein. As shown, the graph 400 includes a vertical axis 420 representing longitude and a horizontal axis 422 representing latitude. The graph 400 utilizes the Cartesian coordinate system to plot different risks. However, other coordinate systems may be used in other embodiments. In an embodiment, the risk to each network element is plotted using a location-based risk identifier having the format: (latitude, longitude). It should be recognized that other formats may be utilized. As shown, a first risk 430 having the location-based risk identifier of (1, 1) and a second risk 440 having the location-based risk identifier of (1, 2) are plotted on the graph 400. As shown, the first risk 430 is within a predetermined threshold distance 450 (e.g., 1 unit, 50 feet, 10 meters, etc.) of the second risk 440. As such, there is a shared risk in excess of a determined threshold between the two network elements based on their respective location-based risk identifiers. To ensure that there are at least two disjoint paths through the network (e.g., network 300), one of the network elements with the shared risk is not selected during path computation.

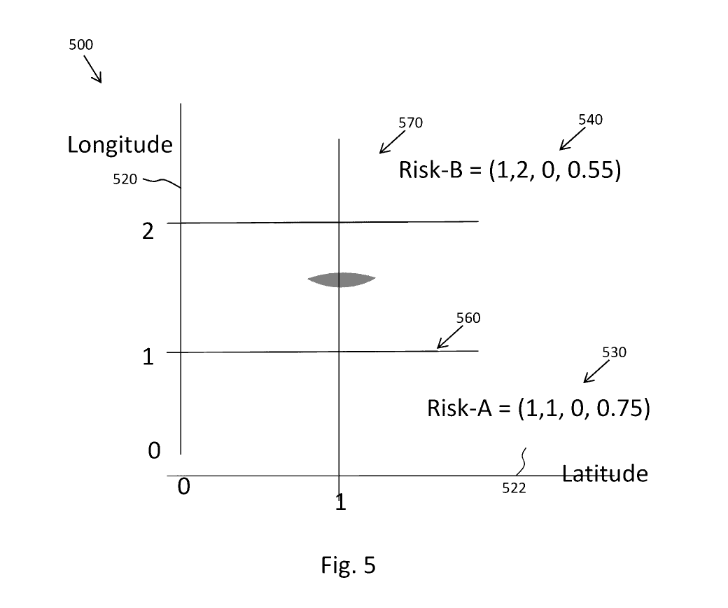

FIG. 5 is a graph 500 depicting the determination of a shared risk in one embodiment using the location-based risk identifiers described herein. As shown, the graph 500 includes a vertical axis 520 representing longitude and a horizontal axis 522 representing latitude. The graph 500 utilizes the Cartesian coordinate system to plot different risks. However, other coordinate systems may be used in other embodiments. In an embodiment, the risk of each network element is plotted using a location-based risk identifier having the format: (latitude, longitude, altitude, radius). It should be recognized that other formats may be utilized. As shown, a first risk 530 having the location-based risk identifier of (1, 1, 0, 0.75) and a second risk 540 having the location-based risk identifier of (1, 2, 0, 0.55) are plotted on the graph 500. Because the first risk 530 includes an optional radius component, the first risk 530 generates a first risk zone 550. Similarly, because the second risk 540 also includes an optional radius component, the second risk 540 generates a second risk zone 570. As shown in the graph 500, the first risk zone 550 and the second risk zone 570 overlap. The overlap indicates that one network element is within a predetermined threshold distance of another network element. As such, there is a shared risk between the two network elements based on their respective location-based risk identifiers. To ensure that there are at least two disjoint paths through the network (e.g., network 300), both of the network elements with the shared risk are not selected during a path computation whose goal is to produce diverse paths.

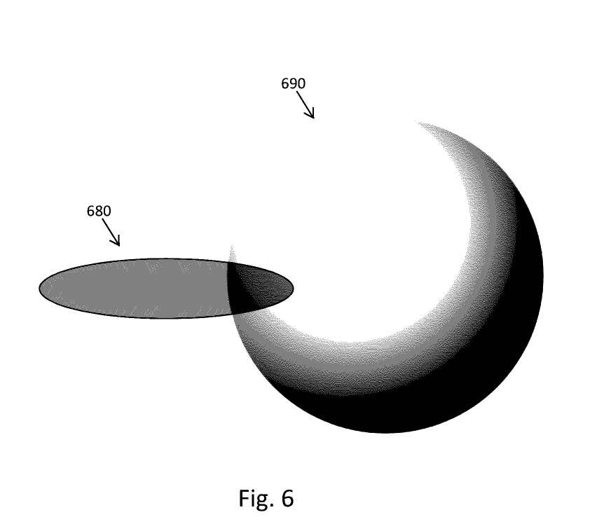

In an embodiment, one of the location-based risk identifiers may have the format: (latitude, longitude, radius), which generates a two-dimensional circle when visually represented. In contrast, another of the location-based risk identifiers may have the format: (latitude, longitude, altitude, radius), which generates a three-dimensional sphere when visually represented. FIG. 6 depicts the intersection (e.g., overlap) of a circle 680 and a sphere 690. The circle 680 and sphere 690 may be visually represented on a graph (e.g., graph 500) to look for any intersection or overlap. As before, any intersection or overlap indicates that one network element is within a predetermined threshold distance of another network element. As such, there is a shared risk between the two network elements based on their respective location-based risk identifiers. To ensure that there are at least two disjoint paths through the network (e.g., network 300), both of the network elements with the shared risk are not selected during a path computation whose goal is to produce diverse paths.

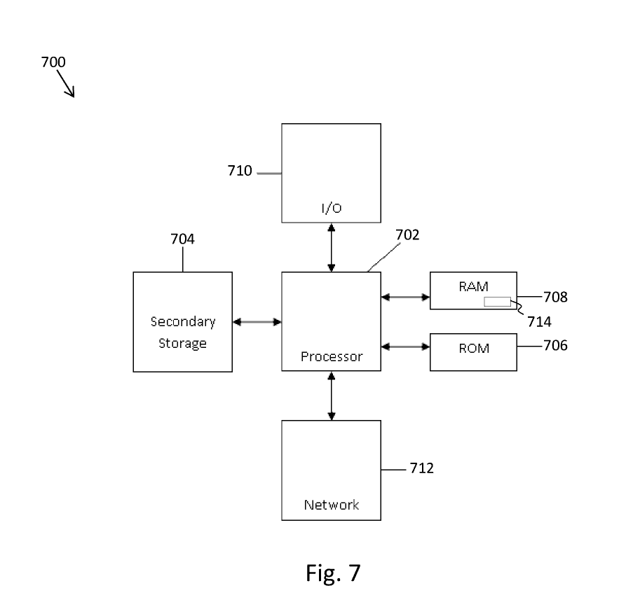

The methods of risk identification or management in a network (e.g., network 300) described herein, including the threshold and risk zone comparisons and/or path computations, may be implemented on any general-purpose network equipment or device, such as a computer or router with sufficient processing power, memory resources, and network throughput capability to handle the necessary workload placed upon it. In an embodiment, the methods may be implemented with input from, for example, a network administrator managing the network equipment or device. FIG. 7 illustrates a typical, general-purpose network equipment 700 suitable for implementing one or more embodiments disclosed herein. The network equipment 700 includes a processor 702 (which may be referred to as a central processor unit or CPU) that is in communication with memory devices including secondary storage 704, read only memory (ROM) 706, random access memory (RAM) 708, input/output (I/O) devices 710, and network connectivity devices 712. The processor 702 may be implemented as one or more CPU chips, or may be part of one or more application specific integrated circuits (ASICs). In an embodiment, one or more of the memory structures stores a risk management module 714 that, when executed by the processor, performs path computations, comparisons, and other functions permitting the methods described herein to be performed.

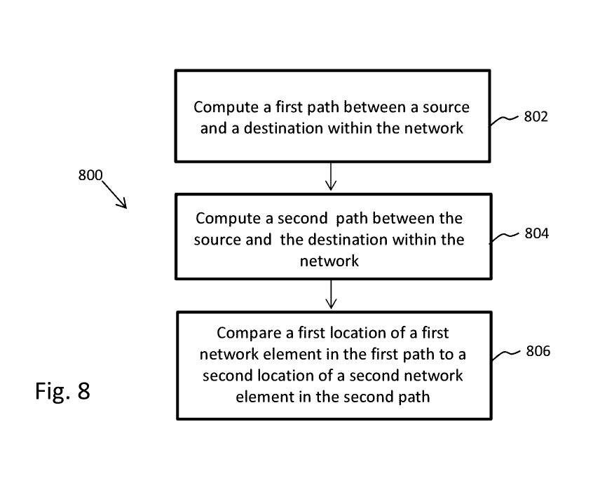

FIG. 8 is a method of managing risk in a network (e.g. network 300) in one embodiment. The method may be performed to determine two or more disjoint paths through the network. The method may be implemented by, for example, a processor (e.g., processor 702 in FIG. 7) and/or other network equipment. In block 802, a first path (e.g., path 302 of FIG. 3) between a source (e.g., source 304 of FIG. 3) and a destination (e.g., destination 306 of FIG. 3) within the network is computed. In block 804, a second path between the source and the destination within the network is computed. The first and second paths are different from each other. In an embodiment, the first and second paths are computed simultaneously. In block 806, a first location of a first network element in the first path is compared to a second location of a second network element in the second path, where the first location is based on a first location-based risk identifier assigned to the first network element prior to computation of the first path, where the second location is based on a second location-based risk identifier assigned to the second network element prior to computation of the second path, and where the first network element and the second network element have a shared risk when the first location is within a predetermined threshold distance of the second location.

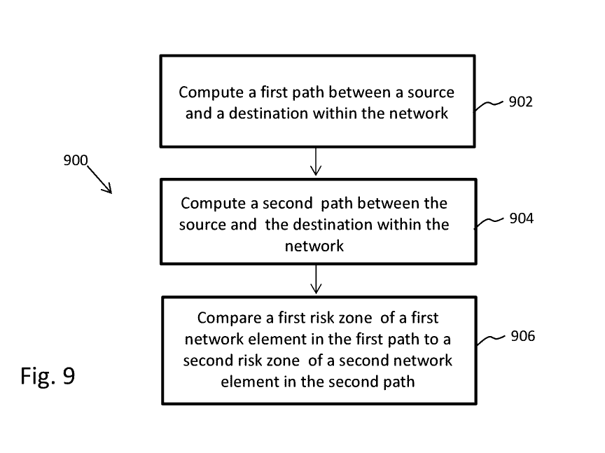

FIG. 9 is a method of managing risk in a network (e.g., network 300) in one embodiment. The method may be performed to determine two or more disjoint paths through the network. The method may be implemented by, for example, a processor (e.g., processor 702 in FIG. 7) and/or other network equipment. In block 902, a first path (e.g., path 302 of FIG. 3) between a source (e.g., source 304 of FIG. 3) and a destination (e.g., destination 306 of FIG. 3) within the network is computed. In block 904, a second path between the source and the destination within the network is computed. In an embodiment, the first and second paths are computed simultaneously. In block 906, a first risk zone (e.g., risk zone 550 of FIG. 5) of a first network element in the first path to a second risk zone (e.g., risk zone 570 of FIG. 5) of a second network element in the second path, where the first risk zone is based on a first location-based risk identifier assigned to the first network element prior to computation of the first path, where the second risk zone is based on a second location-based risk identifier assigned to the second network element prior to computation of the second path, and where an overlap of the first risk zone and the second risk zone indicates that the first network element and the second network element have a shared risk.

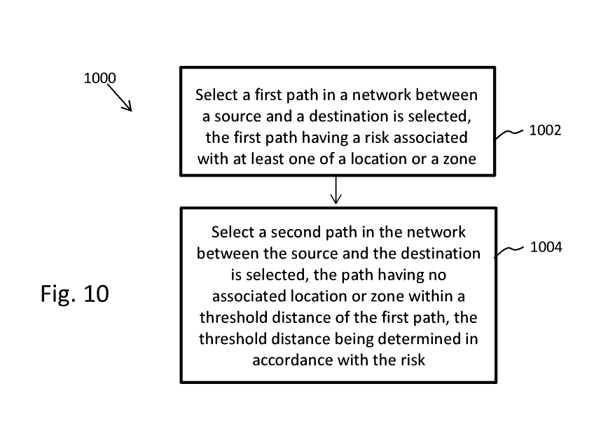

FIG. 10 is a method of managing risk in a network (e.g., network 300) in one embodiment. The method may be performed to determine two or more disjoint paths through the network. The method may be implemented by, for example, a processor (e.g., processor 702 in FIG. 7) and/or other network equipment. In block 1002, a first path in a network between a source and a destination is selected, the first path having a risk associated with at least one of a location or a zone. In block 1004, a second path in the network between the source and the destination is selected, the path having no associated location or zone within a threshold distance of the first path, the threshold distance being determined in accordance with the risk.

From the foregoing, those skilled in the art will appreciate that a network administrator (e.g., a person and/or computer software) is able to check for overlaps in the physical positions of traversed network elements even when different domains are included in the network. Because location-based risk identifiers are used, any need to cross-reference or map the identifiers of one domain in a network to dissimilar identifiers of another domain is eliminated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method of managing risk in a network, comprising:
computing a first path between a source and a destination within the network;
computing a second path between the source and the destination within the network; and
comparing a first location of a first network element in the first path to a second location of a second network element in the second path, the first location is based on a first location-based risk identifier assigned to the first network element prior to computation of the first path, the second location is based on a second location-based risk identifier assigned to the second network element prior to computation of the second path, and the first network element and the second network element have a shared risk when the first location is within a predetermined threshold distance of the second location.

2. The method of claim 1, wherein the first location-based risk identifier comprises a first set of coordinates identifying a location of the first network element, and wherein the second location-based risk identifier comprises a second set of coordinates identifying a location of the second network element.

3. The method of claim 2, wherein the first set of coordinates comprises a first latitude and a first longitude of the first network element and the second set of coordinates comprises a second latitude and a second longitude of the second network element.

4. The method of claim 3, wherein the first set of coordinates comprises a first altitude of the first network element and the second set of coordinates comprises a second altitude of the second network element.

5. The method of claim 1, wherein the first network element and the second network element each comprise a network node.

6. The method of claim 1, wherein the first network element and the second network element each comprise a network link extending between a pair of network nodes.

7. The method of claim 1, wherein the shared risk comprises a power source.

8. The method of claim 1, wherein the shared risk comprises a physical structure.

9. The method of claim 1, wherein the first location-based risk identifier and the second location-based risk identifier share a same format.

10. The method of claim 9, wherein the first network element resides in a first domain monitored by a first network administrator and the second network element resides in a second domain monitored by a second network administrator.

11. A method of managing risk in a network, comprising:
computing a first path between a source and a destination within the network;
computing a second path between the source and the destination within the network; and
comparing a first risk zone of a first network element in the first path to a second risk zone of a second network element in the second path, the first risk zone is based on a first location-based risk identifier assigned to the first network element prior to computation of the first path, the second risk zone is based on a second location-based risk identifier assigned to the second network element prior to computation of the second path, and an overlap of the first risk zone and the second risk zone indicates that the first network element and the second network element have a shared risk.

12. The method of claim 11, wherein the first location-based risk identifier comprises a first set of coordinates identifying a location of the first network element and a first radius establishing the first risk zone, and wherein the second location-based risk identifier comprises a second set of coordinates identifying a location of the second network element and a second radius establishing the second risk zone.

13. The method of claim 12, wherein the first set of coordinates comprises a first latitude and a first longitude of the first network element and the second set of coordinates comprises a second latitude and a second longitude of the second network element.

14. The method of claim 13, wherein the first set of coordinates comprises a first altitude of the first network element and the second set of coordinates comprises a second altitude of the second network element.

15. The method of claim 11, wherein at least one of the first risk zone and the second risk zone is two dimensional.

16. The method of claim 11, wherein at least one of the first risk zone and the second risk zone is three dimensional.

17. The method of claim 11, wherein the first network element and the second network element are each one of a network node and a network link.

18. A risk management device for managing risk in a network, comprising:
a processor operably coupled to a memory; and
a risk management module stored in memory that, when executed by the processor, is configured to:
compute a first path between a source and a destination within the network;
compute a second path between the source and the destination within the network; and
compare a first risk zone of a first network element in the first path to a second risk zone of a second network element in the second path, the first risk zone is based on a first location-based risk identifier assigned to the first network element prior to computation of the first path, the second risk zone is based on a second location-based risk identifier assigned to the second network element prior to computation of the second path, and an overlap of the first risk zone and the second risk zone indicates that the first network element and the second network element have a shared risk.

19. The device of claim 18, wherein the first location-based risk identifier comprises a first set of coordinates identifying a location of the first network element and a first radius establishing the first risk zone, and wherein the second location-based risk identifier comprises a second set of coordinates identifying a location of the second network element and a second radius establishing the second risk zone.

20. The device of claim 18, wherein the risk management module maps the first and second risk zones to a common coordinate system to compare the first and second risk zones.
